(19) United States
(12) Patent Application Publication
(10) Pub. No.: US 2026/0141539 A1
(43) Pub. Date: May 21, 2026

(54) OBJECT TRACKING APPARATUS BASED ON META LEARNING, OBJECT TRACKING METHOD THEREOF, AND MODEL LEARNING METHOD THEREOF

(71) Applicants: Hyundai Motor Company, Seoul (KR); Kia Corporation, Seoul (KR); Singapore University of Technology and Design, Singapore (SG)

(72) Inventors: Dezhao Huang, Singapore (SG); Evan Ling, Singapore (SG); Weiling Chen, Singapore (SG); Xiaofei Hui, Shandong (CN); Pengfei Wang, Singapore (SG); Zile Yang, Guangdong Province (CN); Jun Liu, Lancaster (GB); Kian Eng Ong, Singapore (SG); Jing Wu, Jiangsu (CN)

(21) Appl. No.: 19/213,803

(22) Filed: May 20, 2025

(30) Foreign Application Priority Data
Nov. 20, 2024 (KR) 10-2024-0166658

(51) Int. Cl. G06T 7/246; G06V 20/40

(52) U.S. Cl. CPC G06T 7/251; G06V 20/41; G06T 2207/20081; G06T 2207/20084; G06T 2207/30241

(57) ABSTRACT

An object tracking apparatus based on meta learning receives inputs of a video frame and a target initialization sentence, specifies, when the input video frame is a first video frame of a video sequence, a target from the first video frame based on the target initialization sentence, detects, when the input video frame is not a first video frame, objects that may interact with the specified target from the input video frame, determines a target and a related object from the corresponding video frame by predicting an interaction between the specified target and the detected objects, determines the target and the related object until the last video frame of the video sequence, and predicts trajectories of the target and the related object.

### CROSS REFERENCE TO RELATED APPLICATION

The present application claims under 35 U.S.C. § 119(a) the benefit of Korean Patent Application No. 10-2024-0166658, filed Nov. 20, 2024, the entire contents of which are incorporated by reference herein.

### BACKGROUND

### (a) Technical Field

The present disclosure relates to object tracking, and more particularly, to an object tracking apparatus based on meta learning, an object tracking method thereof, and a model learning method thereof.

### (b) Description of the Related Art

Single object tracking aims at tracking positional trajectories of a target in a video. The target should be specified in a first frame of the video and detected and tracked in subsequent frames of the video.

Object tracking is one of the most important tasks in computer vision used in a variety of applications such as crowd management, robotics, autonomous vehicle tracking, and the like.

An object tracking method based on target initialization in the first frame may be classified into two types: bounding-box based object tracking, and language-based object tracking.

Abounding box-based object tracking method typically initializes a target with the target's coordinates in the first frame, and the language-based object tracking method typically initializes the target using language description in the first frame.

The above-described object tracking methods may be insufficient and/or incomprehensive considering various real-life situations as they track only position information of the target in the frames.

Acquiring semantic trajectories of a target may be useful and beneficial in a wide range of real situations including safety, security, well-being, productivity, sales, and the lie.

For example, in a factory or a supply chain management environment, knowing semantic trajectories of workers or vehicles may be helpful in minimizing the risk of accidents and injuries.

For example, when semantic trajectories of a target (person or vehicle), such as ‘How safe is it for a worker to operate a forklift and transport goods’, ‘How safely a driver drives to prevent collision’, ‘How long a worker has been working and whether the worker needs a break’, and the like, are known, various measures such as adopting a system for preventing accidents and injuries can be taken.

Accordingly, an object tracking technique capable of tracking semantic trajectories of a target (e.g., positional trajectories of surrounding objects, interactions between the target and surrounding objects over time, and the like), as well as positional trajectories of the target, would be beneficial.

The matters described above as the background art are only to improve understanding of the background of the present disclosure, and should not be accepted as acknowledging that they correspond to the prior art already known to those skilled in the art.

### SUMMARY

The present disclosure provides an object tracking technique capable of tracking semantic trajectories of a target, as well as positional trajectories of the target.

Another objective of the present disclosure is to provide an object tracking technique that can localize and track a target based on an input target initialization sentence, acquire semantic trajectories of the target through tracking, and improve comprehensive tracking and understanding of the target based on the semantic trajectories of the target.

Another objective of the present disclosure is to provide an object tracking technique that can be applied to various data distributions (i.e., various situations) by applying virtual learning, virtual testing, and meta-optimization.

Another objective of the present disclosure is to provide an object tracking apparatus including the object tracking technique proposed in the present disclosure, an object tracking method thereof, and a model learning method thereof.

The technical problems to be solved by the present disclosure are not limited to the technical problems mentioned above, and unmentioned other technical problems will be clearly understood by those skilled in the art from the following description.

An object tracking apparatus according to an embodiment of the present disclosure for achieving the above objects may include a memory in which a model for object detection and tracking is stored; and a processor that executes the model.

According to an embodiment of the present disclosure, as the model is executed, the processor may receive a video frame and a target initialization sentence as an input, specify, when the input video frame is a first video frame of a video sequence, a target from the first video frame based on the target initialization sentence, detect, when the input video frame is not a first video frame, objects that may interact with the specified target from the input video frame, determine a target and a related object from the corresponding video frame by predicting an interaction between the specified target and the detected objects, determine the target and the related object until a last video frame of the video sequence, and predict trajectories of the target and the related object.

According to an embodiment, when the target and the related object are determined, the processor may determine the target by matching the specified target and the detected objects, and determine other objects as candidate related objects.

According to an embodiment, the processor may predict an interaction between the target and each candidate related object based on features of the target and features of the candidate related objects, and determine a related object that interacts with the target among the candidate related objects.

According to an embodiment, the processor may predict an interaction between the target and each candidate related object in a current video frame by connecting features of the target of the current video frame with features of the candidate related objects of each of a preset number of previous video frames and then inputting the features into a Long-Short Term Memory (LSTM)model.

According to an embodiment, the processor may add a class indicating a non-related object to a related category of non-related objects that do not interact with the target among the candidate related objects.

According to an embodiment, the trajectory may include positional trajectories and semantic trajectories of the target and each related object.

According to an embodiment, the processor may perform meta-learning on the model based on a training data set.

According to an embodiment, the training data set may include a support data set and a plurality of query data sets.

According to an embodiment, the plurality of query data sets may have a data distribution different from that of the support data set in object class and interaction type.

According to an embodiment, the processor may update the model by reflecting a loss of virtual training performed based on the support data set and a loss of virtual testing performed based on the plurality of query data sets.

According to an embodiment, the processor may perform the virtual testing based on the plurality of query data sets for a virtually updated model by reflecting the loss of the virtual training.

According to an embodiment, a vehicle includes the object tracking apparatus.

According to an embodiment, the object tracking method according to an embodiment of the present disclosure includes the steps of: receiving, by a processor, a video sequence and a target initialization sentence as an input; specifying, by the processor, a target from a first video frame of the video sequence based on the target initialization sentence; detecting, by the processor, objects that may interact with the specified target from other input video frames of the video sequence; predicting, by the processor, interactions between the specified target and the detected objects, determining, by the processor, a target and a related object from the corresponding video frame based on the predicted interactions; and determining, by the processor, the target and the related object until a last video frame of the video sequence, and predicting trajectories of the target and the related object.

According to an embodiment, the step of determining a target and a related object may include determining the target by matching the specified target and the detected objects, and determining other objects as candidate related objects.

According to an embodiment, the step of determining a target and a related object may include predicting an interaction between the target and each candidate related object based on features of the target and features of the candidate related objects, and determining a related object that interacts with the target among the candidate related objects.

According to an embodiment, the step of determining a target and a related object may include predicting an interaction between the target and each candidate related object in a current video frame by connecting features of the target of the current video frame with features of the candidate related objects of each of a preset number of previous video frames and then inputting the features into a Long-Short Term Memory (LSTM)model.

According to an embodiment, the step of determining a target and a related object may include adding a class indicating a non-related object to a related category of non-related objects that do not interact with the target among the candidate related objects.

The object tracking model learning method according to an embodiment of the present disclosure is a method of learning an object tracking model by an object tracking apparatus, the method comprising the steps of: training, by a processor, the object tracking model based on a support data set and a plurality of query data sets; and performing, by the processor, meta-optimization on parameters of the object tracking model based on a loss calculated by performing virtual training based on the support data set, and a loss calculated by performing virtual testing based on the plurality of query data sets.

According to an embodiment, the plurality of query data sets may have a data distribution different from that of the support data set in object class and interaction type.

According to an embodiment, the virtual testing may be performed on the updated object tracking model based on the loss calculated during the virtual training.

According to an embodiment, the object tracking model learning method may perform the meta-optimization on the parameters of the object tracking model based on Equation 1,

$${min}_{θ} [ L ( {D}^{S} ; θ ) + {\sum }_{n = 1}^{N} L ( {D}_{n}^{q} ; {θ}^{′} ) ] , \qquad Equation 1$$

wherein
L(D^{s}; θ) is the loss of parameter θ calculated during the virtual training

$${\sum }_{n = 1}^{N} L ( {D}_{n}^{q} ; {θ}^{′} )$$

is the loss of parameter θ′ calculated during the virtual testing, and θ′ is the parameter updated through the virtual training.

According to an embodiment, the object tracking model learning method may perform update on the parameters of the object tracking model based on Equation 2,

$$θ ← θ - β {∇}_{θ} [ L ( {D}^{s} ; θ ) + {\sum }_{n = 1}^{N} L ( {D}_{n}^{q} ; θ - α {∇}_{θ} L ( {D}^{S} ; θ ) ) ] , \qquad [ Equation 2 ]$$

α denotes a weight, and β denotes a learning rate of total optimization.

According to an embodiment of the present disclosure, an object tracking technique capable of tracking semantic trajectories of a target, in addition to positional trajectories of the target, may be provided.

Accordingly, since a semantic trajectory of a target predicted using the object tracking technique according to the embodiment may include a bounding box of the target, bounding boxes and classes of surrounding related objects, and interactions over time, in-depth tracking and understanding of the target can be provided.

When the object tracking technique like this is used, semantic trajectories of workers or vehicles may be known in a factory, a supply chain management environment, or the like, and it is expected based on this that the risk of accidents and injuries can be minimized.

In addition, according to an embodiment of the present disclosure, since virtual testing of the object tracking model is performed based on query data sets having various data distributions, and the result of the virtual testing is applied to meta-optimization to update the object tracking model, the generalization ability of the object tracking model can be improved and usefully applied to various real situations.

The effects that can be obtained from the present disclosure are not limited to the effects mentioned above, and unmentioned other effects can be clearly understood by those skilled in the art from the following description.

### BRIEF DESCRIPTION OF THE DRAWINGS

FIG. 1 is a view showing the configuration of an object tracking apparatus according to an embodiment of the present disclosure.

FIG. 2 is a functional block diagram showing the operation of a processor according to an embodiment of the present disclosure.

FIG. 3 is a flowchart illustrating an object tracking method according to an embodiment of the present disclosure.

FIG. 4 is a flowchart illustrating a method of learning an object tracking model according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

When it is determined, in describing the embodiments disclosed in this specification, that the detailed descriptions of related known techniques may obscure the gist of the embodiments disclosed in this specification, the detailed description will be omitted. In addition, the accompanying drawings are only for easy understanding of the embodiments disclosed in this specification, and the technical spirit disclosed in this specification is not limited by the accompanying drawings, and should be understood to include all changes, equivalents, and substitutes included in the spirit and technical scope of the present disclosure.

Although terms including ordinal numbers such as first, second, and the like may be used to describe various components, the components are not limited by the terms. The terms are used only to distinguish one component from the others.

Singular expressions include plural expressions unless the context clearly dictates otherwise.

When a component is mentioned as being “connected” or “coupled” to another component, it should be understood that although the component may be directly connected or coupled to another component, other components may exist in the middle. On the contrary, when a component is mentioned as being “directly connected” or “directly coupled” to another element, it should be understood that no other component exists in the middle.

Hereinafter, the embodiments disclosed in this specification will be described in detail with reference to the accompanying drawings, and the same reference numerals are given to the same or similar components regardless of reference symbols, and duplicate description thereof will be omitted.

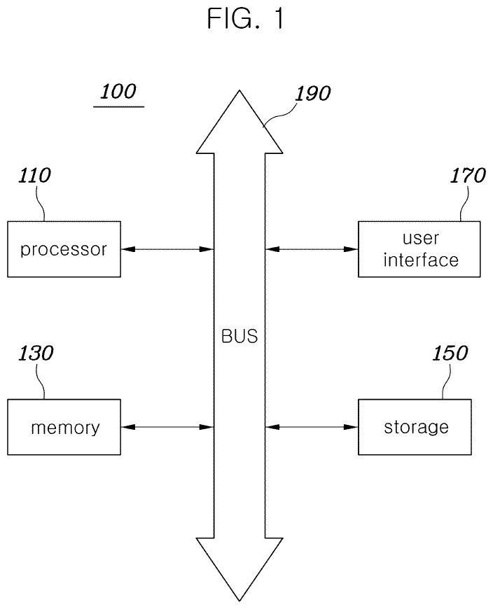

FIG. 1 is a view showing the configuration of an object tracking apparatus 100 according to an embodiment of the present disclosure.

Referring to FIG. 1, an object tracking apparatus 100 according to an embodiment of the present disclosure may be a computing device implemented to track objects within an input video sequence. For example, the object tracking apparatus 100 may be implemented in a system that monitors a factory for producing vehicles, and may receive a video sequence from cameras that capture the environment within the factory. For example, the object tracking apparatus 100 may be implemented in a vehicle and receive a video sequence from cameras installed on the vehicle.

According to an embodiment, the object tracking apparatus 100 may include a processor 110, a memory 130, a storage 150, a user interface 170, and a bus 190.

The processor 110 may be a data processing device implemented in hardware having a physical structure for executing desired operations.

The processor 110 controls the overall operation of each component of the object tracking apparatus 100. The processor 110 may be configured to include at least one among a Central Processing Unit (CPU), a Micro Processor Unit (MPU), a Micro Controller Unit (MCU), a Graphic Processing Unit (GPU), and any type of processor well known in the art of the present disclosure. In addition, the processor 110 may perform operations on at least one application or program for executing methods/operations according to various embodiments of the present disclosure.

The memory 130 stores various data, commands and/or information. The memory 130 may load one or more computer programs from the storage 150 to execute methods/operations according to various embodiments of the present disclosure. For example, the memory 130 may be Random Access Memory (RAM) or Dynamic Random Access Memory (DRAM), but it is not limited thereto, and may be configured to include at least any one type of memory well known in the art of the present disclosure.

The storage 150 may non-transitorily store one or more computer programs. The storage 150 may be configured to include non-volatile memory such as flash memory or the like, a hard disk, a removable disk, or any type of computer-readable recording media well known in the art of the present disclosure.

For example, a computer program may include one or more instructions implementing methods/operations according to various embodiments of the present disclosure. When a computer program is loaded on the memory 130, the processor 110 may perform methods/operations according to various embodiments of the present disclosure by executing one or more instructions.

The user interface 170 may receive commands, data, information, and the like from the outside of the object tracking apparatus 100. The user interface 170 may output operation results of the object tracking apparatus 100. For example, the user interface 170 may include a keyboard, a mouse, a monitor, a touch screen, and the like.

The bus 190 provides communication functions between components of the object tracking apparatus 100. The bus 190 may be implemented as various types of buses, such as an address bus, a data bus, a control bus, and the like.

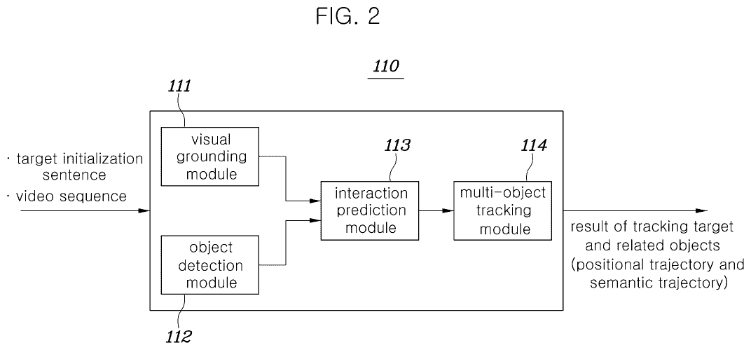

FIG. 2 is a functional block diagram showing the operation of a processor 110 according to an embodiment of the present disclosure.

The processor 110 according to an embodiment may receive a target initialization sentence and a video sequence as an input, and track semantic trajectories of the target based on the target initialization sentence and the video sequence.

Here, the target initialization sentence is a sentence that describes the target and is used to spatially specify the target in a video frame and start tracking. In addition, the semantic trajectories of the target may include a bounding box of the target, bounding boxes and classes of surrounding related objects, and interactions over time.

To this end, an object tracking model may be mounted on the processor 110. The operations of the processor 110 described below may be performed by the object tracking model mounted on the processor 110, and the object tracking function of the object tracking apparatus 100 may be accomplished by the object tracking model.

Referring to FIG. 2, the processor 110 (or object tracking model) may include a visual grounding module 111, an object detection module 112, an interaction prediction module 113, and a multi-object tracking module 114.

The visual grounding module 111 may receive a target initialization sentence and a first video frame of the video sequence, and may specify a target from the first video frame based on the target initialization sentence.

The visual grounding module 111 may generate an embedding vector from the target initialization sentence using a previously learned language model. For example, the language model may be selected from language models well-known in the technical field of the present disclosure, such as BERT, Global Vectors (GloVe), fastText, and Embedding from Language Models (ELMo).

The visual grounding module 111 may specify a target from the first video frame based on the embedding vector.

The object detection module 112 may receive a video sequence, and detect an object that may interact with the target from the video sequence based on a preset object detection algorithm. Here, the object may include the target.

For example, the object detection module 112 may detect an object from the video sequence using a YOLOx-based object detection model, and the object detection model or the object detection algorithm that the object detection module 112 uses is not limited thereto this.

According to an embodiment, the object detection module 112 extracts features f_t from the input video frame l_t, and detect a bounding box b_(t,i) and an object class c_(t,i) of an object in the video frame based on the extracted features.

For example, the object detection module 112 may be configured to include a backbone for extracting features from an input video frame, a neck for collecting the extracted features, and a head for detecting a bounding box and an object class of an object based on the features collected by the neck.

To extract high-dimensional features, the backbone may be configured as a Darknet53 model, the neck may be configured as a feature pyramid network (FPN) model, and the head may be configured as a YOLOx model. However, the types of models configuring the backbone, the neck, and the head are not limited thereto.

For example, a ResNet-50 model, a SpinNet model, or the like may configure the backbone, a Path Augmented Network (PAN) model, a Neural Architecture Search-FPN (NAS-FPN) model, a Fully-connected FPN model, an Adaptively Spatial Feature Fusion (ASFF) models, or the like may configure the neck, and a single shot multi-box detector (SSD) model, a RetinaNet model, or the like may configure the head.

According to embodiments, the object detection module 112 may further extract intermediate features f_(t,i) corresponding to the bounding box based on the Region of Interest (Rol) alignment technique to acquire more information about the object.

The interaction prediction module 113 may predict interactions between the target and the related objects.

The interaction prediction module 113 may determine a target by matching a target specified by the visual grounding module 111 and an object detected by the object detection module 112 for the input video frame l_t, and other objects may be determined as candidate related objects.

The interaction prediction module 113 may predict interactions of each pair based on the features of the target and the features of the candidate related objects. For example, the interaction prediction module 113 may predict an interaction type based on a convolutional neural network (CNN) model, but it is not limited thereto.

For example, assuming that the target is A and the candidate related objects are B, C, and D, the interaction prediction module 113 may predict the interaction of A and B, the interaction of A and C, and the interaction of A and D.

Information acquired from previous video frames may be useful for predicting interactions in the next video frame.

Accordingly, the embodiment of the present disclosure uses a Long-Short Term Memory (LSTM) model to predict interactions by using the intermediate features of several video frames as an input.

The interaction prediction module 113 may predict interactions between the target and the candidate related objects from the current video frame by connecting features of the target of the current video frame with features of the candidate related objects of the last K previous video frames and then inputting the features into the LSTM model, and determine a candidate related object that interacts with the target among the candidate related objects.

Hereinafter, the candidate related object that interacts with the target is referred to as a ‘related object’.

The interaction prediction module 113 may indicate a non-related object by adding a ‘background’ class to a related category of candidate related objects that do not interact with the target (non-related objects) among the candidate related objects.

Accordingly, the object tracking model may improve object tracking efficiency and performance by focusing on tracking of related objects, without performing tracking on the non-related objects that do not interact with the target.

In this way, the interaction prediction module 113 may filter out non-related objects in the process of predicting the interactions between the target and the related objects.

Accordingly, since non-related objects are excluded and only related objects are input into the multi-object tracking module 114, the semantic trajectories of the object may be focused on providing information on the target.

The multi-object tracking module 114 may predict trajectories of the target and trajectories of the related objects, and track the target and the related objects based on the trajectories of each target and related objects. Here, the trajectories may include positional trajectories and semantic trajectories.

For example, the multi-object tracking module 114 may predict trajectories of the target and the related objects based on the ByteTrack method.

According to an embodiment, when the target and the related objects of two consecutive video frames are input, the multi-object tracking module 114 may predict trajectories of the target and each related object by matching the target and the related objects of the two consecutive video frames.

For example, the multi-object tracking module 114 may predict trajectories of the target by matching the target in each of consecutive first and second video frames, and predict trajectories of the related objects by matching the related objects in each of the first and second consecutive video frames.

Meanwhile, semantic tracking is not a simple combination of tasks, and allows to construct a framework for people to conveniently track targets through a sentence by applying semantic information to object tracking.

Frameworks based on semantic tracking are capable of end-to-end learning. In the process of predicting positional trajectories and interactions in relation to a target and related objects, the object tracking model may learn reciprocal information. The interaction information may be used for tracking the target and the related objects, and positional trajectory information may be used for predicting interactions between the target and the related objects.

For example, the interaction ‘lean’ may imply that the positional movements of two objects (target and related object) are the same. As another example, a trajectory pattern such as a related object moving away from the target may suggest an interaction of ‘throw’.

These examples suggest the possibility of constructing a joint framework for semantic tracking.

Simultaneously considering prediction of positional trajectories and prediction of interactions generates a new task.

For example, the phrase “adult drink from bottle” may be used much more frequently than the phrase “adult clean bottle”. Therefore, when a model trained to be biased to the phrases predicts the interaction between the target “adult” and the related object “bottle”, it may predict the interaction as “adult drink from bottle” even when the actual interaction is “adult clean bottle”.

In this way, simultaneously considering the prediction of positional trajectories and the prediction of interactions requires solution of the inaccurate prediction problem of a model trained in a biased way.

As is known from the example, performance of the model may be affected by distribution of data used during the training. In addition, in a real situation, there may be various situations where data distribution does not match data distribution of training data sets.

The semantic tracking model may acquire semantic trajectories including the class and interaction type of an object.

An embodiment of the present disclosure proposes an object tracking model that can improve performance of the model, considering different data distributions in object class and interaction type.

Meta-learning aims at improving generalization ability of a model by adopting virtual testing when the model learns, and it is effective in improving the generalization ability for new tasks, domains, and the like.

In order to improve object tracking performance, the object tracking apparatus 100 (or object tracking model) according to an embodiment of the present disclosure may perform meta-learning.

According to an embodiment, a training data set may be divided into a support data set and N query data sets.

The support data set may be used for virtual training, and the N query data sets may be used for virtual testing.

Here, each of the N query data sets has a data distribution different from that of the support data set in object class and interaction type. N is a plurality of natural numbers and may be selectively determined according to resources, specifications of the object tracking apparatus, or the like.

The object tracking apparatus 100 may improve the generalization performance of the model by optimizing the model by conducting virtual testing based on N query data sets having a data distribution different from that of the support data set in object class and interaction type.

According to an embodiment, meta-learning for the model may be accomplished in three steps of virtual training, virtual testing, and meta-optimization.

The object tracking apparatus 100 may perform virtual training on the model based on the support data set D^{s}, calculate a loss L(D^{s}; θ) according to the virtual training, and virtually update the model parameter θ based on the loss.

Here, the loss L(D^{s}; θ) may mean the loss of the parameter θ when the model is virtually trained based on the support data set D^{s}.

Accordingly, through the virtual training based on the support data set, the model may be virtually updated, and a virtually updated model can be acquired.

The object tracking apparatus 100 may perform virtual testing on the virtually updated model based on N query data sets

$${\{ {D}_{n}^{q} \}}_{n = 1}^{N}$$

in order to evaluate the virtually updated model parameter.

Here, the virtual testing may be performed to evaluate the generalization ability for various data distributions.

The object tracking apparatus 100 may calculate the loss

$$L ( {D}_{n}^{q} ; {θ}^{′} )$$

based on the virtual testing performed on the query data set

$${\{ {D}_{n}^{q} \}}_{n = 1}^{N}$$

using the virtually updated model.

Here, the model parameter θ′ means the model parameter updated through the virtual training.

The loss on the query data set may be used as feedback for the generalization ability of the virtually updated model.

The object tracking apparatus 100 may perform meta-optimization to update the model.

According to an embodiment, the object tracking apparatus 100 may optimize the model parameter θ based on the loss L(D^{s}; θ) calculated during the virtual training and the loss

$$L ( {D}_{n}^{q} ; {θ}^{′} )$$

calculated during the virtual testing.

The object tracking apparatus 100 may perform meta-optimization on the model parameter θ based on Equation 1.

$${min}_{θ} [ L ( {D}^{S} ; θ ) + {\sum }_{n = 1}^{N} L ( {D}_{n}^{q} ; {θ}^{′} ) ] \qquad [ Equation 1 ]$$

Here, L(D^{s}; θ) means loss of parameter θ when the model is virtually trained based on the support data set D^{s}, and

$$L ( {D}_{n}^{q} ; {θ}^{′} )$$

means loss of parameter θ′ when the virtually updated model is virtually tested based on the query data set

$${\{ {D}_{n}^{q} \}}_{n = 1}^{N} .$$

Accordingly, the object tracking apparatus 100 may improve generalization ability of the model by reflecting the loss L(D^{s}; θ) acquired based on the virtual training performed on the support data set D^{s} when the model is updated, and improve the generalization ability of the model for various data distributions by reflecting the loss acquired based on the virtual testing performed on the query data set v when the model is updated.

The object tracking apparatus 100 may update the model parameter θ based on Equation 2.

$$θ ← θ - β {∇}_{θ} [ L ( {D}^{s} ; θ ) + {\sum }_{n = 1}^{N} L ( {D}_{n}^{q} ; θ - α {∇}_{θ} L ( {D}^{S} ; θ ) ) ] \qquad [ Equation 2 ]$$

Here, α denotes the weight, and β denotes the learning rate of total optimization.

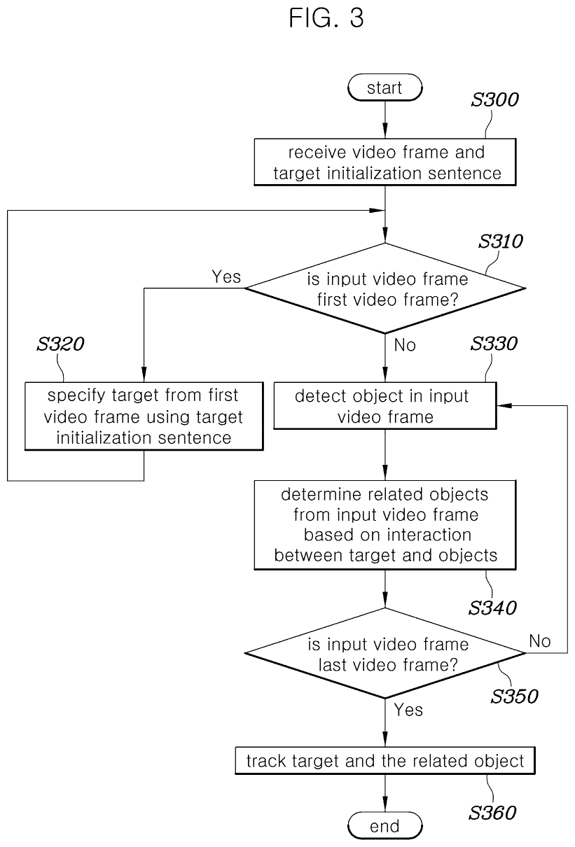

FIG. 3 is a flowchart illustrating an object tracking method according to an embodiment of the present disclosure.

Referring to FIG. 3, the object tracking apparatus 100 (or object tracking model) may receive a video frame and a target initialization sentence (S300), and determine whether the input video frame is the first video frame of the video sequence (S310).

When the input video frame is the first video frame of the video sequence (S310—Yes), the object tracking apparatus 100 may specify a target from the first video frame based on the target initialization sentence (S320).

At step S320, the object tracking apparatus 100 may generate an embedding vector from the target initialization sentence using a previously learned language model, and specify a target from the first video frame based on the embedding vector.

After performing step S320, the object tracking apparatus 100 may perform step S310 to process the video frames following the first video frame.

When the input video frame is not the first video frame of the video sequence (S310—No), the object tracking apparatus 100 may detect an object that may interact with the target from the input video frame (S330).

At step S330, the object tracking apparatus 100 may extract features from the input video frame, and detect a bounding box and an object class of an object in the video frame based on the extracted features.

At step S330, the object tracking apparatus 100 may further extract intermediate features corresponding to the bounding box based on the Region of Interest (Rol) alignment technique to acquire more information about the object.

After step S330, the object tracking apparatus 100 may predict an interaction between the target and an object (S340).

At step S340, the object tracking apparatus 100 may determine the target by matching the target specified at step S320 and the object detected at step S330, and determine other objects as candidate related objects.

In addition, the object tracking apparatus 100 may predict an interaction between the target and each candidate related object based on the features of the target and the features of the candidate related objects.

According to the embodiment, the object tracking apparatus 100 may predict interactions between the target and the candidate related objects from the current video frame by connecting features of the target of the current video frame with features of the candidate related objects of the last K previous video frames and then inputting the features into the LSTM model, and determine a candidate related object, i.e., related object, that interacts with the target among the candidate related objects.

In addition, the object tracking apparatus 100 may indicate a non-related object by adding a ‘background’ class to a related category of candidate related objects that do not interact with the target (non-related objects) among the candidate related objects.

After step S340, the object tracking apparatus 100 may determine whether the input video frame is the last video frame (S350).

When the input video frame is not the last video frame (S350—No), the object tracking apparatus 100 may perform steps S330 and S340 for the next video frame.

When the input video frame is the last video frame (S350—Yes), the object tracking apparatus 100 may predict trajectories of the target and the related objects and track the target and the related objects (S360).

Here, the trajectory may include positional trajectories and semantic trajectories, and the object tracking apparatus 100 may perform positional tracking and semantic tracking for the target and the related objects.

At step S360, the object tracking apparatus 100 may predict trajectories of the target and the related objects based on the ByteTrack method.

According to an embodiment, the object tracking apparatus 100 may predict trajectories of the target and each related object by matching the target and the related objects of two consecutive video frames.

For example, the object tracking apparatus 100 may predict trajectories of the target by matching the target in each of consecutive first and second video frames, and predict trajectories of the related objects by matching the related objects in each of the first and second consecutive video frames.

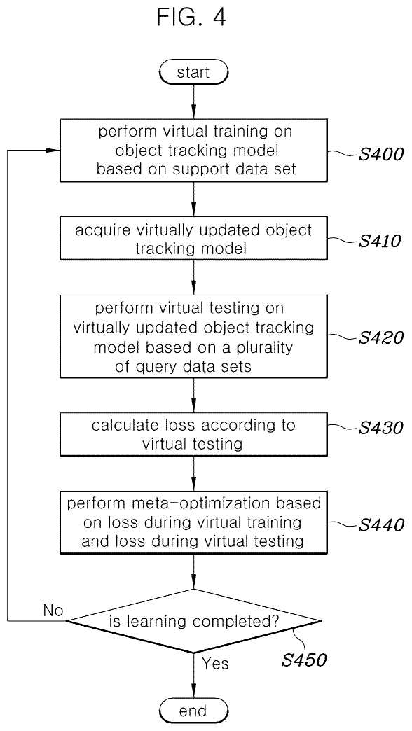

FIG. 4 is a flowchart illustrating a method of learning an object tracking model according to an embodiment of the present disclosure.

The object tracking apparatus 100 may perform meta-learning on the object tracking model based on a training data set including a support data set and a plurality of query data sets having a data distribution different from that of the support data set in object class and interaction type.

Referring to FIG. 4, the object tracking apparatus 100 may perform virtual training on the object tracking model based on the support data set (S400) and acquire a virtually updated object tracking model(S410).

At step S410, the object tracking apparatus 100 may acquire the virtually updated object tracking model by calculating a loss according to the virtual training and virtually updating model parameters based on the loss.

Thereafter, the object tracking apparatus 100 may perform virtual testing on the virtually updated object tracking model based on a plurality of query data sets (S420) and calculate a loss according to the virtual testing (S430).

Thereafter, the object tracking apparatus 100 may perform meta-optimization on the parameters of the object tracking model based on the loss acquired during the virtual training and the loss acquired during the virtual testing (S440).

Thereafter, the object tracking apparatus 100 may determine whether learning of the object tracking model is completed (S450), and terminate the operation of learning the object tracking model when the learning is completed (S450—Yes), or may perform step S400 when the learning is not completed (S450—No).

Although embodiments of the present disclosure have been described in more detail with reference to the accompanying drawings, the present disclosure is not necessarily limited to these embodiments, and various modifications can be made without departing from the technical spirit of the present disclosure. Accordingly, the embodiments disclosed in this specification are not intended to limit the technical spirit of the present disclosure, but rather to explain it, and the scope of the technical spirit of the present disclosure is not limited by these embodiments. Therefore, the embodiments described above should be understood in all respects as illustrative and not restrictive. The scope of protection of the present disclosure should be interpreted in accordance with the claims, and all technical spirits within the equivalent scope should be interpreted as being included in the scope of rights of the present disclosure.

What is claimed is:

1. An object tracking apparatus, the apparatus comprising:
a memory in which a model for object detection and tracking is stored; and
a processor that is configured to execute the model, wherein upon executing the model, the processor is configured to:
receive a video frame and a target initialization sentence as an input,
specify, in response to the input video frame being a first video frame of a video sequence, a target from the first video frame based on the target initialization sentence,
detect, in response that the input video frame not being the first video frame, objects that may interact with the specified target from the input video frame,
determine a target and a related object from the video frame by predicting an interaction between the specified target and the detected objects,
determine the target and the related object until a last video frame of the video sequence, and
predict trajectories of the target and the related object.

2. The apparatus of claim 1, wherein in response to determining the target and the related object, the processor is configured to determine the target by matching the specified target and the detected objects, and determine other objects as candidate related objects.

3. The apparatus of claim 2, wherein the processor is configured to predict an interaction between the target and each candidate related object based on features of the target and features of the candidate related objects, and determine the related object that interacts with the target among the candidate related objects.

4. The apparatus of claim 2, wherein the processor is configured to predict an interaction between the target and each candidate related object in a current video frame by connecting features of the target of the current video frame with features of the candidate related objects of each of a preset number of previous video frames and then inputting the features into a Long-Short Term Memory (LSTM) model.

5. The apparatus of claim 3, wherein the processor is configured to add a class indicating a non-related object to a related category of non-related objects that do not interact with the target among the candidate related objects.

6. The apparatus of claim 1, wherein the trajectories include positional trajectories and semantic trajectories of the target and each related object.

7. The apparatus of claim 1, wherein the processor is configured to perform meta-learning on the model based on a training data set, wherein the training data set includes a support data set and a plurality of query data sets, and the plurality of query data sets has a data distribution different from that of the support data set in object class and interaction type.

8. The apparatus of claim 7, wherein the processor is configured to update the model by reflecting a loss of virtual training performed based on the support data set and a loss of virtual testing performed based on the plurality of query data sets.

9. The apparatus of claim 8, wherein the processor is configured to perform the virtual testing based on the plurality of query data sets for a virtually updated model by reflecting the loss of the virtual training.

10. A vehicle comprising the object tracking apparatus of claim 1.

11. An object tracking method comprising the steps of:
receiving, by a processor, a video sequence and a target initialization sentence as an input;
specifying, by a processor, a target from a first video frame of the video sequence based on the target initialization sentence;
detecting, by a processor, objects that may interact with the specified target from other input video frames of the video sequence;
predicting, by a processor, interactions between the specified target and the detected objects, and determining a target and a related object from the corresponding video frame based on the predicted interactions; and
determining, by a processor, the target and the related object until a last video frame of the video sequence, and predicting trajectories of the target and the related object.

12. The method of claim 11, wherein the step of determining the target and the related object includes determining the target by matching the specified target and the detected objects, and determining other objects as candidate related objects.

13. The method of claim 12, wherein the step of determining the target and the related object includes predicting an interaction between the target and each candidate related object based on features of the target and features of the candidate related objects, and determining a related object that interacts with the target among the candidate related objects.

14. The method of claim 12, wherein the step of determining the target and the related object includes predicting an interaction between the target and each candidate related object in a current video frame by connecting features of the target of the current video frame with features of the candidate related objects of each of a preset number of previous video frames and then inputting the features into a Long-Short Term Memory (LSTM) model.

15. The method of claim 12, wherein the step of determining the target and the related object includes adding a class indicating a non-related object to a related category of non-related objects that do not interact with the target among the candidate related objects.

16. A method of learning an object tracking model by an object tracking apparatus, the method comprising the steps of:
training, by a processor, the object tracking model based on a support data set and a plurality of query data sets; and
performing, by the processor, meta-optimization on parameters of the object tracking model based on a loss calculated by performing virtual training based on the support data set, and a loss calculated by performing virtual testing based on the plurality of query data sets.

17. The method of claim 16, wherein the plurality of query data sets has a data distribution different from that of the support data set in object class and interaction type.

18. The method of claim 16, wherein the virtual testing is performed on the updated object tracking model based on the loss calculated during the virtual training.

19. The method of claim 16, wherein the meta-optimization is performed on the parameters of the object tracking model based on Equation 1,
$${min}_{θ} [ L ( {D}^{S} ; θ ) + {\sum }_{n = 1}^{N} L ( {D}_{n}^{q} ; {θ}^{′} ) ] \qquad [ Equation 1 ]$$
wherein
L(D^{s}; θ) is the loss of parameter θ calculated during the virtual training
$${\sum }_{n = 1}^{N} L ( {D}_{n}^{q} ; {θ}^{′} )$$
is the loss of parameter θ′ calculated during the virtual testing, and θ′ is the parameter updated through the virtual training.

20. The method of claim 16, wherein update is performed on the parameters of the object tracking model based on Equation 2,
$$θ ← θ - β {∇}_{θ} [ L ( {D}^{s} ; θ ) + {\sum }_{n = 1}^{N} L ( {D}_{n}^{q} ; θ - α {∇}_{θ} L ( {D}^{S} ; θ ) ) ] , \qquad [ Equation 2 ]$$
wherein
α denotes a weight, and β denotes a learning rate of total optimization.
